(19) United States
(12) Patent Application Publication
(10) Pub. No.: US 2005/0247741 A1
(43) Pub. Date: Nov. 10, 2005

(54) Paste product dispenser, typically a cosmetic for lip makeup

(76) Inventor: Fabrice Dieudonat, Fosses (FR)

Correspondence Address: YOUNG & THOMPSON, 745 SOUTH 23RD STREET, 2ND FLOOR, ARLINGTON, VA, 22202, US

(21) Appl. No.: 11/102,806

(22) Filed: Apr. 11, 2005

(30) Foreign Application Priority Data
May 7, 2004 (FR) 04 04938

(51) Int. Cl. G01F 11/00

(52) U.S. Cl. 222/405

(57) ABSTRACT

The dispenser includes: a) a body having a bottom, a sidewall, b) a dispensing end piece having a side skirt capable of cooperating with the sidewall of the body, and a dispensing head,
c) a propulsion elements operated by relative manual rotation of the body with respect to the dispensing end piece along the axial direction, the propulsion elements including a piston and a central rod cooperating with the said piston, a cap (5).

### DOMAIN OF THE INVENTION

The invention relates to the domain of makeup, typically lip makeup.

It relates to packaging of typically viscous products that flow under pressure, such as creams, pastes, etc.

### STATE OF THE ART

There are many known lipstick dispensers or tubes, for example like those described in European patent applications No. 96500011, 98500016, 98500088, 99420027, 99420072 comprising a body and a cap.

The bodies of these lipstick tubes comprise a propulsion mechanism typically composed of three coaxial parts including, in order from the outside towards the inside, an outer body forming a tube skirt and typically supporting two spiral grooves on its inner surface, a tubular element fixed to the bottom of the tube and carrying diametrically opposite axial orifices, a support for the lipstick fitted with two diametrically opposite studs, the said studs passing through the said axial orifices and cooperating with the spiral grooves such that relative rotation of the said body with respect to the said bottom causes axial displacement of the said support and therefore the said lipstick.

Deodorant dispensers are also known, for example like those described in French patent No. 2 573 734 or European patent No. 0 462 925.

These dispensers typically comprise a body provided with a side skirt and a bottom, a piston forming a support for the deodorant stick cooperating with a central screw that is rotated by an outer knob forming all or part of the said bottom.

### PROBLEMS THAT ARISE

Different types of problems arise with dispensers known according to the state of the art.

Firstly, these dispensers are only suitable for solid stick products.

But relatively fluid formulas are increasingly used even for lip makeup, that would not be suitable for packaging in traditional lipstick tubes.

Furthermore, these relatively fluid formulas may have particular Theological properties that may require a certain amount of shear during their use.

Furthermore, users would like to be able to visually observe the real colour of the packaged product without necessarily wanting to see the propulsion mechanism used to move the product to be dispensed.

Moreover, dispenser manufacturers in particular would like dispensers that can be used for packaging different product families, particularly cosmetics.

Finally, there is a permanent demand in the field of cosmetics for the development and launching of new products that are substantially different from known products.

### DESCRIPTION OF THE INVENTION

A fluid or paste product dispenser according to the invention has an axial direction and comprises:
a) a body forming a typically cylindrical axial cavity capable of containing the said product, the said body comprising a bottom, a sidewall and an upper opening,
b) a dispensing end piece comprising a side skirt capable of cooperating with the said sidewall of the said body so as to be axially fixed to the said sidewall through a solidarisation means while being free in rotation, and a dispensing head provided with at least one orifice capable of dispensing or applying the said product,
c) a means of propulsion of the said product operated by relative manual rotation of the said body with respect to the said dispensing end piece along the said axial direction, the said propulsion means comprising a piston and a central rod cooperating with the said piston at its centre, the said piston comprising a threaded part cooperating with a complementary threaded part facing it, the said rotation causing relative rotation of the said threaded part with respect to the said complementary threaded part, so as to entrain axial displacement of the said piston with respect to the said central rod moving the said product in the axial direction,
d) a cap typically including a head and a skirt and capable of closing off the said dispensing head of the said upper end piece,
and is characterised in that:
1) the said dispenser includes an inner partition delimiting an inner chamber capable of storing the said product and capable of containing the said piston and the said central rod of the said propulsion means, the said inner partition comprising an inner head forming an upper wall and a typically cylindrical inner skirt forming a lower opening at its lower end, the said inner partition being in the turned over or “bell” position with respect to the said body,
2) the said propulsion means is chosen such that the said manual rotation of the said propulsion means pushes the said piston and the said product contained in the said inner chamber downwards, i.e. towards the bottom of the said body,
3) the said inner partition cooperates with the said body and the said dispensing end piece so as to form a flow space forming a passage enabling the said product to flow from the said lower opening as far as the said dispensing head, the said product being capable of flowing typically through a lower passage between the said lower end and the said bottom, and then flowing upwards, i.e. in the direction of the said dispensing head through a peripheral passage between the said inner skirt of the said inner partition and the said sidewall of the said body and the said side skirt of the said dispensing end piece to reach a head space in communication with the said orifice, and thus dispense the said product.

The dispenser according to the invention solves the problems that arise.

Firstly, the dispenser according to the invention can be used with a wide variety of makeup formulas in the form of fluid pastes.

Secondly, the design of this dispenser imposes that the packaged product follows a path equal to at least the height of the said inner skirt in the said inner partition, such that any application of the product will involve a flow or preliminary circulation of the product that can lead to fluidisation of the product if it is thixotropic, or otherwise an increase in the apparent viscosity of the product if it is rheopexic, before its application, typically on the lips if the said product is a lipstick.

This flow can also mix the product constituents if the formula of the said product tends to become less homogenous over time.

This flow may also orient these particles before application if the product is a dispersion containing solid particles, so as to obtain specific optical effects.

Furthermore according to one embodiment that will be mentioned in the detailed description of the invention, it is quite clear that the propulsion mechanism will not be visible from the outside, even if the product flow might be visible from the outside.

The dispenser according to the invention can be used for different products provided that their Theological properties and particularly their viscosity, are similar and typically correspond to a paste type product capable of flowing, either by itself or under a mechanical stress typically caused by pressure applied by the said piston during the said manual rotation.

Finally, the dispenser according to the invention is significantly different from dispensers according to prior art.

### DESCRIPTION OF THE FIGURES

All figures relate to dispensers (1) or elements of dispensers (1) according to the invention.

FIG. 1a is an axial section of an empty dispenser (1) in an axial plane containing the said axial direction (10), and FIG. 1a is an enlarged view of FIG. 2b. FIG. 1b is a partial cross sectional view in plane A-A in FIG. 1a perpendicular to the said axial direction (10).

FIGS. 1c to 1e are top views of the dispensing head (31) illustrating different variant orifices (310); several small circular orifices (311) in FIG. 1c, several parallel transverse slits (312, 312′) in FIGS. 1d and 1e, these slits being oriented differently, either parallel to the axial plane in FIG. 1a or perpendicular to this plane.

FIGS. 2a to 2f relate to the dispenser (1) in FIGS. 1a and 1b.

FIG. 2a is a view similar to FIG. 1a, the dispenser being full of a product (7) to be dispensed.

FIG. 2b is an axial section along the axial plane A-A in FIG. 2f.

FIG. 2c, similar to FIG. 2b is an axial section along the axial plane C-C in FIG. 2f.

FIG. 2d is a cross sectional view in the transverse plane B-B in FIG. 2b.

FIG. 2e is a top view of the open dispenser (1′).

FIG. 2f is a top or bottom view of the dispenser (1), corresponding to a top view of the cap (5) or a view from underneath the body (2) of the dispenser (1).

FIGS. 2g and 2h correspond to FIGS. 1c to 1e and illustrate other variant orifices (310).

FIGS. 3a to 4c illustrate a variant of the embodiment of the dispenser (1) according to FIGS. 1a and 2a, the cap (5) having been removed.

In this variant, the said central rod (41) is a threaded rod (41′) whereas in the variant in FIG. 1a, the inner skirt (62) of the inner partition (6) is a threaded inner skirt (62′).

FIG. 3a corresponds to FIG. 1a.

FIG. 3b is a cross-sectional view through the piston (40) in the transverse plane B-B in FIG. 3a.

FIG. 3c is an enlarged view of a cross-section in the A-A plane in FIG. 3a illustrating axial click-fitting and solidarisation of the dispensing end piece (3) and the inner partition (6) in rotation.

FIGS. 4a and 4b show an axial cross section of the dispensing end piece (3) and the inner partition (6) before click-fitting.

FIG. 4c shows an axial sectional view of the dispensing end piece (3) and the inner partition (6) click fitted together and turned upside down so that the said inner chamber (60) can be filled with the said product (7).

FIGS. 5a to 6b relate to another embodiment of the dispenser (1) in which the said central rod (41) is fixed in rotation to the dispensing end piece (3), whereas it was fixed to the bottom (21) in the embodiments of the dispenser illustrated in FIGS. 1a, 2a and 3a.

FIGS. 5a to 5c illustrate a variant in which the said central rod (41) is a threaded rod (41′) as is the case in FIG. 3a.

FIGS. 5a and 5c correspond to FIGS. 4b and 4a respectively.

FIG. 5b corresponds to FIG. 4c.

FIGS. 6a and 6b illustrate another variant in which, as in the case shown in FIG. 1a, the inner skirt (62) of the inner partition (6) is a threaded inner skirt (62′).

FIGS. 7a to 7h are partial and diagrammatic axial sections of various embodiments of the dispensing head (31) of dispensing end pieces (3).

In FIGS. 7a to 7d, the dispensing head (31) is a median plane perpendicular to the said axial direction (10).

In FIGS. 7e to 7h, the dispensing head (31) is in a median plane forming an angle α with the said axial direction (10).

FIGS. 7a to 7e illustrate an embodiment of orifices (310) in which the said median plane forms a plane surface (314), an embodiment represented diagrammatically by a solid line and a central straight segment in the corresponding FIGS. 7b and 7g.

FIGS. 7c and 7g, corresponding to FIGS. 7b and 7f respectively, illustrate the case in which the said median plane forms a convex surface (316).

FIGS. 7d and 7h, corresponding to FIGS. 7b and 7f respectively, illustrate the case in which the said median plane forms a concave surface (315).

FIGS. 8a to 9b illustrate cross-sections of different possible forms of the dispenser (1).

In each of these figures, the central part comprises two concentric circles that diagrammatically show the section or profile (34) of the lower part (35) of the dispensing end piece (3) and the section of the said upper part (28) of the body (2), these parts (28) and (35) being concentric to enable relative rotation of the said body with respect to the said dispensing end piece (3).

The upper part of the Figure shows the section of the dispensing head (31) in solid line, the dashed line showing a reminder of the profile (34).

The lower part of the Figure shows the section or profile (27) of the lower part (29) of the sidewall (22) of the body in solid line, and also the cross section (52) of the cap (5) provided that the said dispenser (1) has a constant section or profile over its entire height, when closed. The part (29) of the body (2) and the cap (5) form the visible parts of the closed dispenser (1), the said lower part (35) of the said dispensing end piece (3) typically being hidden by the cap (5) when the dispenser (1) is closed.

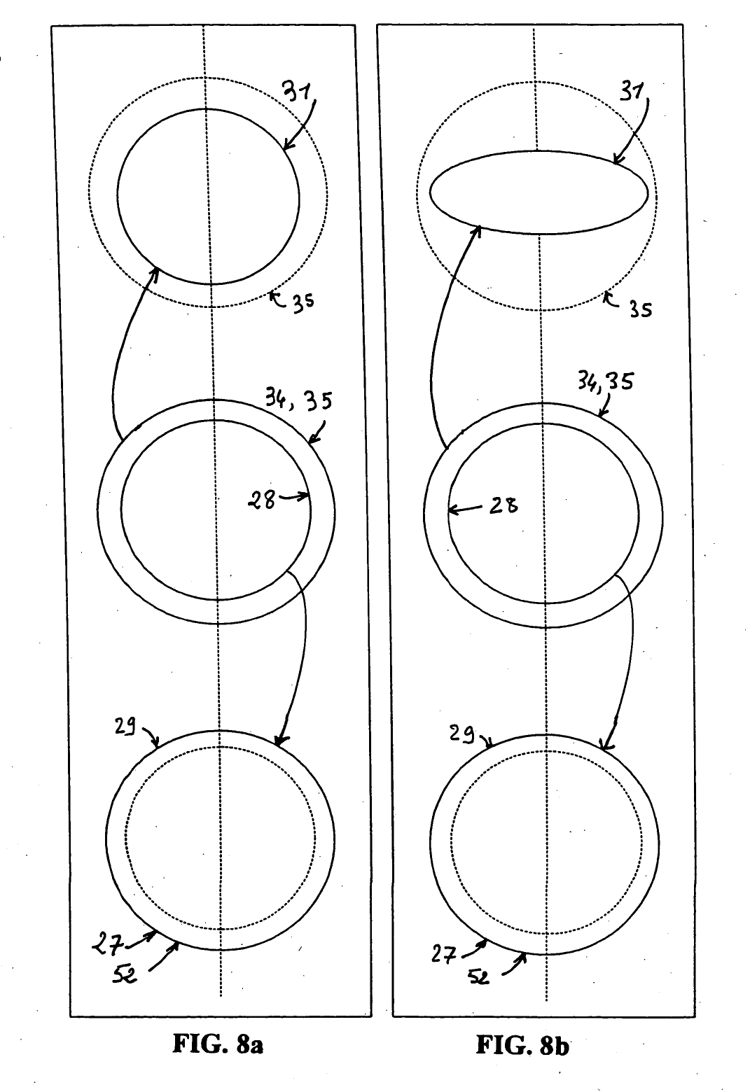

In the embodiment in FIG. 8a, the lower part (29) of the body (2) and the dispensing head (31) have a circular or round shaped cross section.

In the embodiment in FIG. 8b, the lower part (29) of the body (2) has a circular or round cross section, while the dispensing head (31) has an oval shaped cross section.

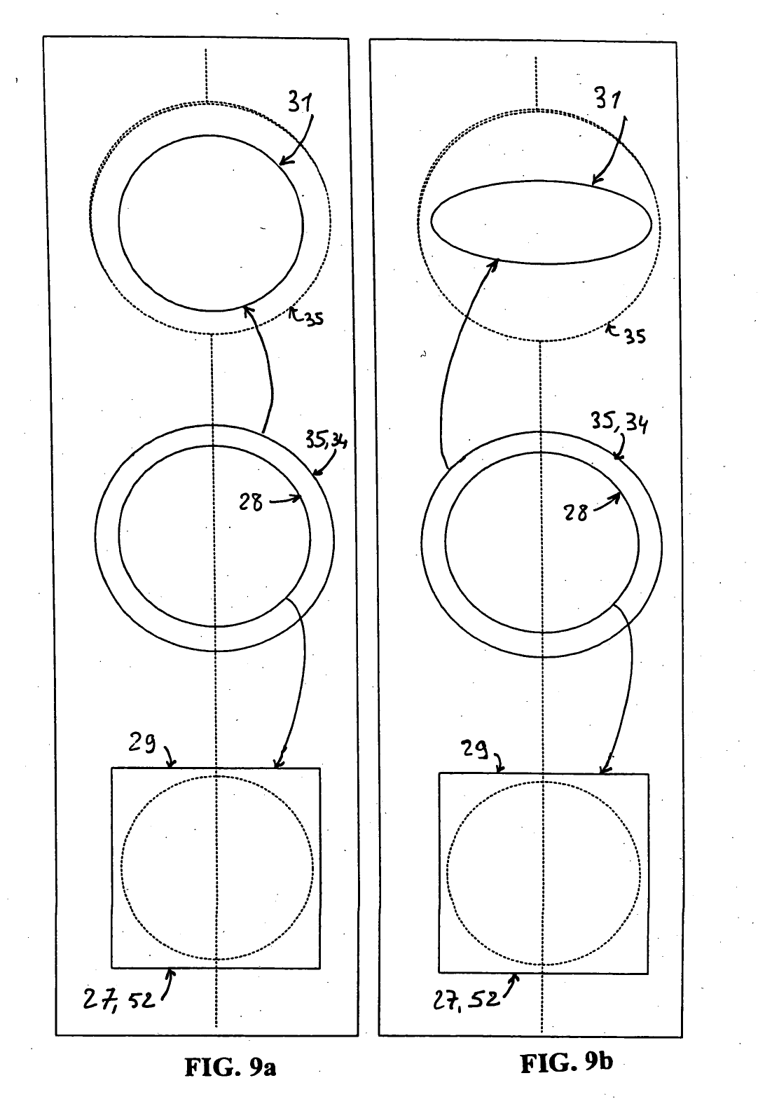

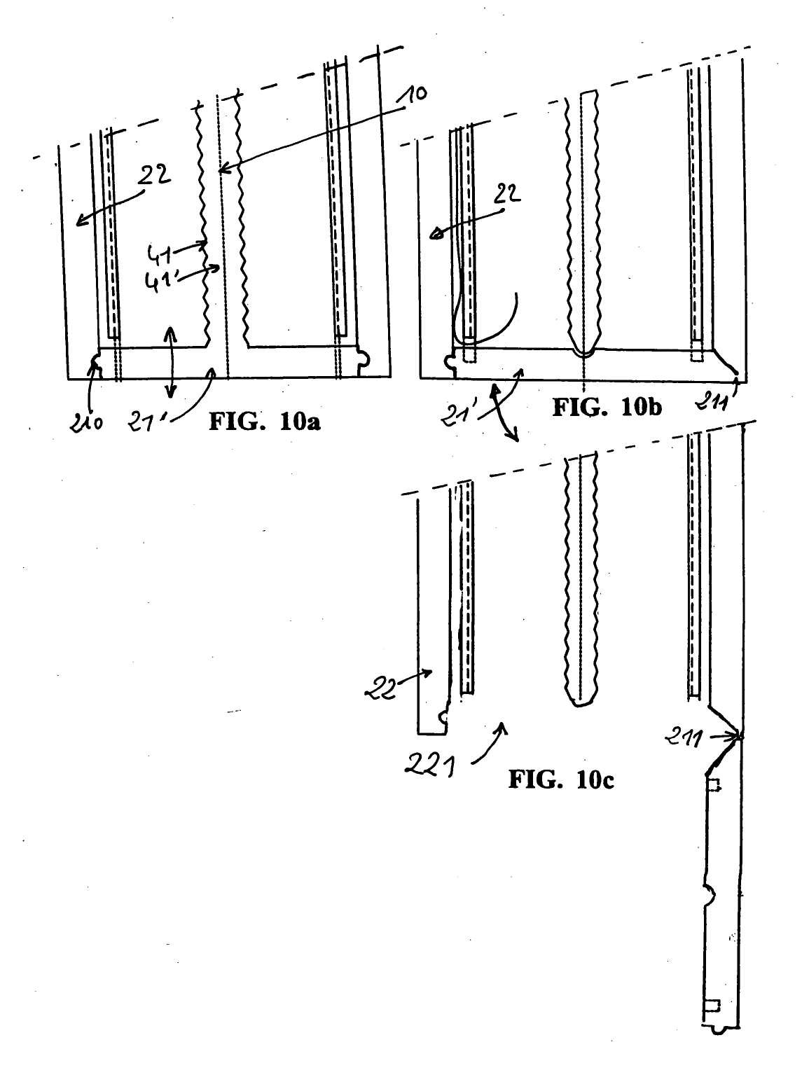

In the embodiment in FIG. 9a, the lower part (29) of the body (2) has a square cross section, while the dispensing head (31) has a round or circular shaped cross section.

In the embodiment in FIG. 9b, the lower part (29) of the body (2) has a square cross section, while the dispensing head (31) has an oval shaped cross section.

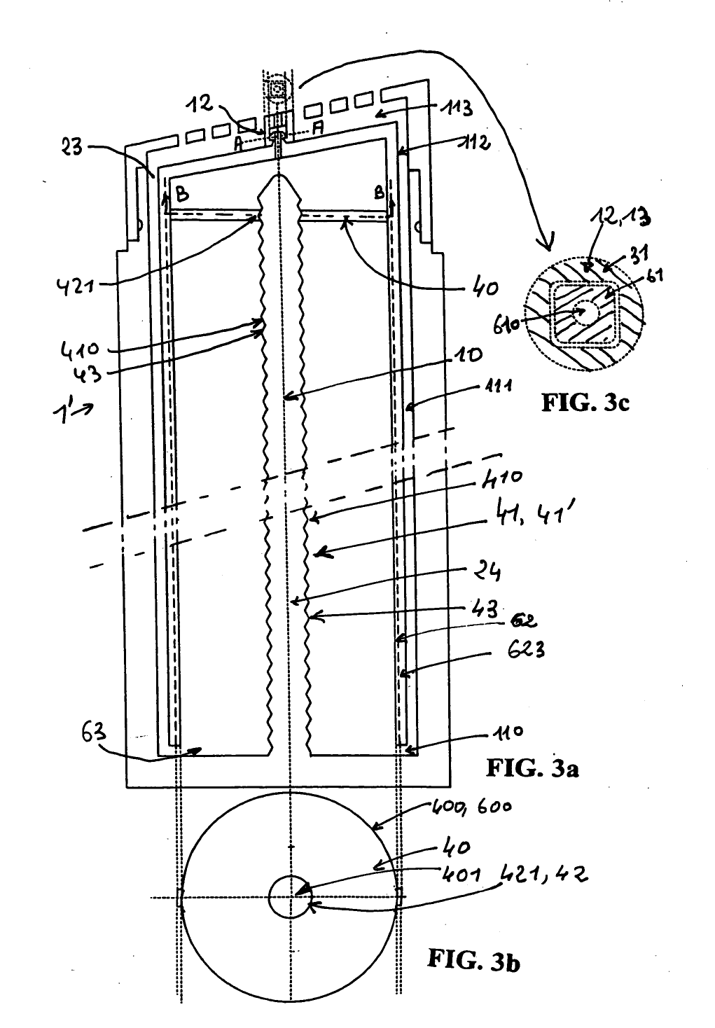

FIGS. 10a to 10c show partial axial sections similar to the lower part of FIG. 3a. They illustrate other embodiments of dispensers (1) in which the said bottom (21) of the body (2) forms a moving part (21′) particularly so that the said dispenser (1) can be filled through the bottom.

FIG. 10a illustrates an embodiment in which the said moving part (21′) fixed to the central rod (41) may be separated from the skirt (22) of the said body (2).

FIGS. 10b and 10c illustrate another embodiment in which the said moving part (21′) is connected through a thinned part forming a hinge (211) to the skirt (22) of the body (2).

In FIG. 10b, as in FIG. 10a, the said moving part (21′) closes off the lower opening (221) formed by the said sidewall (22).

The said moving part (21′) in FIG. 10c is in the “open” position.

### DETAILED DESCRIPTION OF THE INVENTION

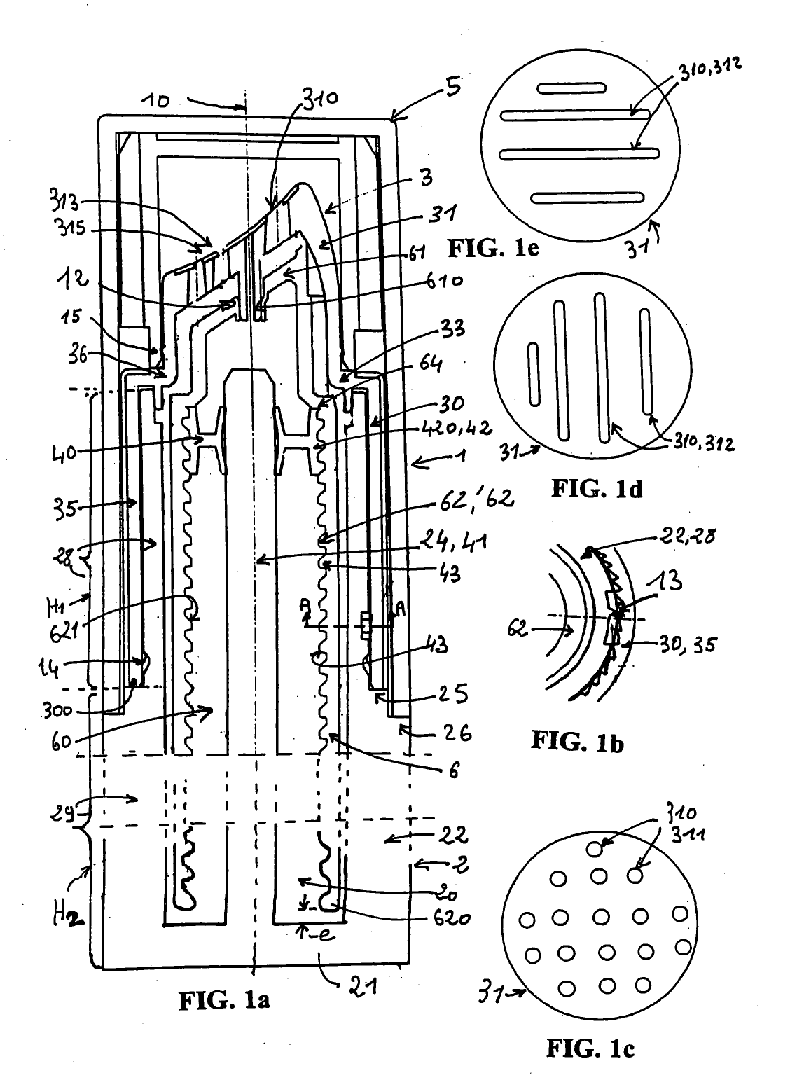

According to the invention, and according to an embodiment illustrated in FIGS. 1a and 3a, the said central rod (41) may be a central rod (24) fixed to the said bottom (21) of the said body (2) and may typically form a one-piece part with the said bottom (21), the said bottom (21) typically forming a one-piece part with the said sidewall (22) of the said body (2), the said inner partition (6) then being fixed in rotation to the said dispensing end piece (3). In this case, the said body (2) and the said central rod (41, 24) form a single moulded part made of thermoplastic material.

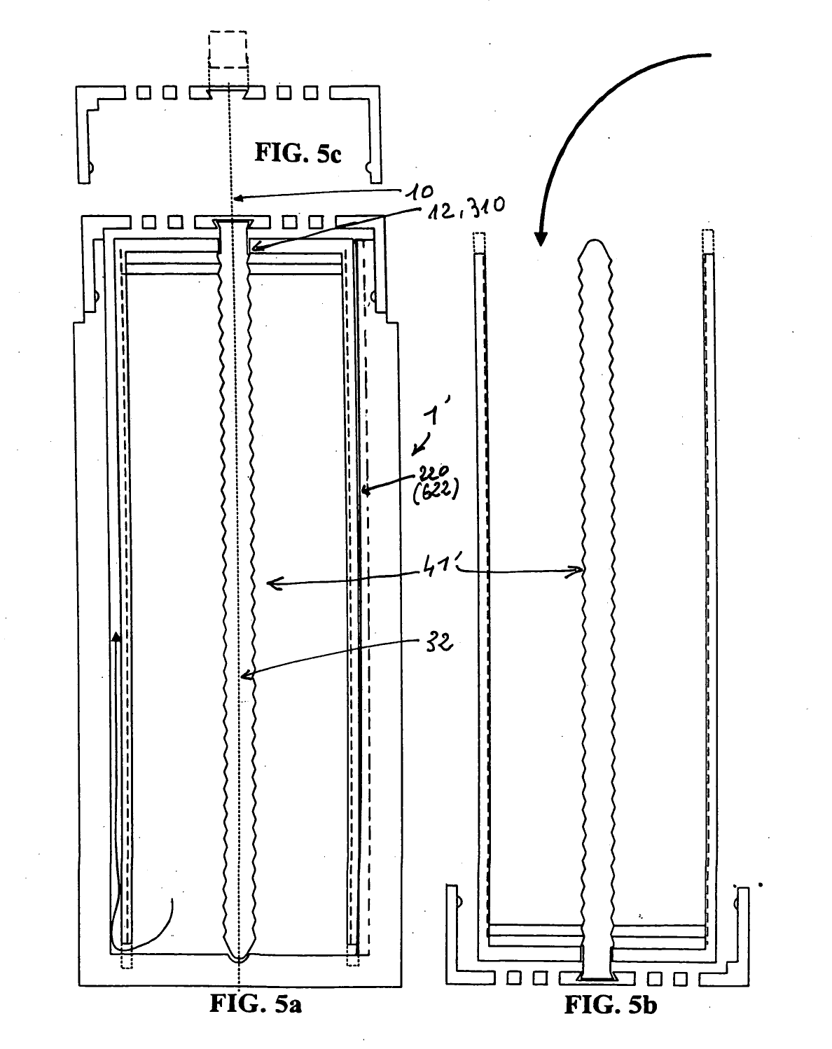

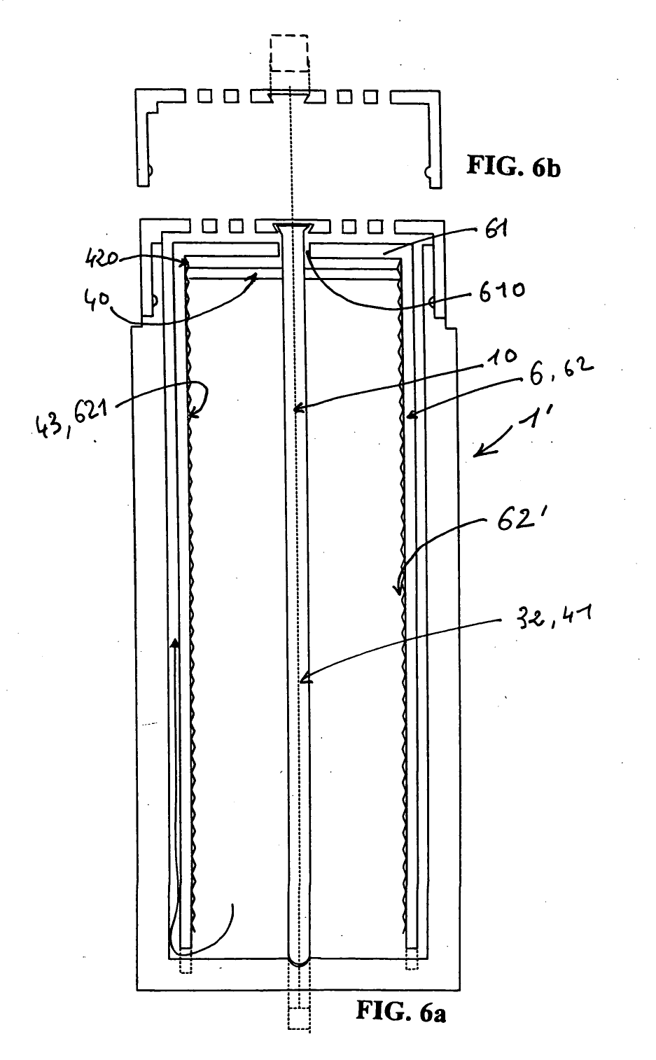

According to another embodiment illustrated in FIGS. 5a and 6a, the said central rod (41) may be a central rod (32) fixed to the said dispensing end piece (3) due to an upper orifice (610) formed in the said upper wall (61) of the said inner partition (62), the said inner partition (62) then being fixed in rotation to the said body (2).

In general, the upper wall (61) of the said lower partition (6) comprises a leak that may be made by the said upper orifice (610) such that it does not create a vacuum between the said piston (40) and the said upper wall (61), as the said piston (40) moves towards the bottom (21) of the said body (2), the said product gradually being consumed.

According to an embodiment illustrated in FIGS. 1a and 6a, the said threaded part (42) of the said piston (40) may be an external peripheral threaded part (420), the said inner skirt (62) of the said inner partition (6) being provided with an inner thread (621) on its inner surface forming the said complementary threaded part (43), the said inner surface of the said inner skirt (62) being cylindrical.

According to another embodiment illustrated in FIGS. 3a and 5a, the said threaded part (42) of the said piston (40) may be an inner central part (421), the said central rod (41) being provided with an outer thread (410) forming the said complementary threaded part (43).

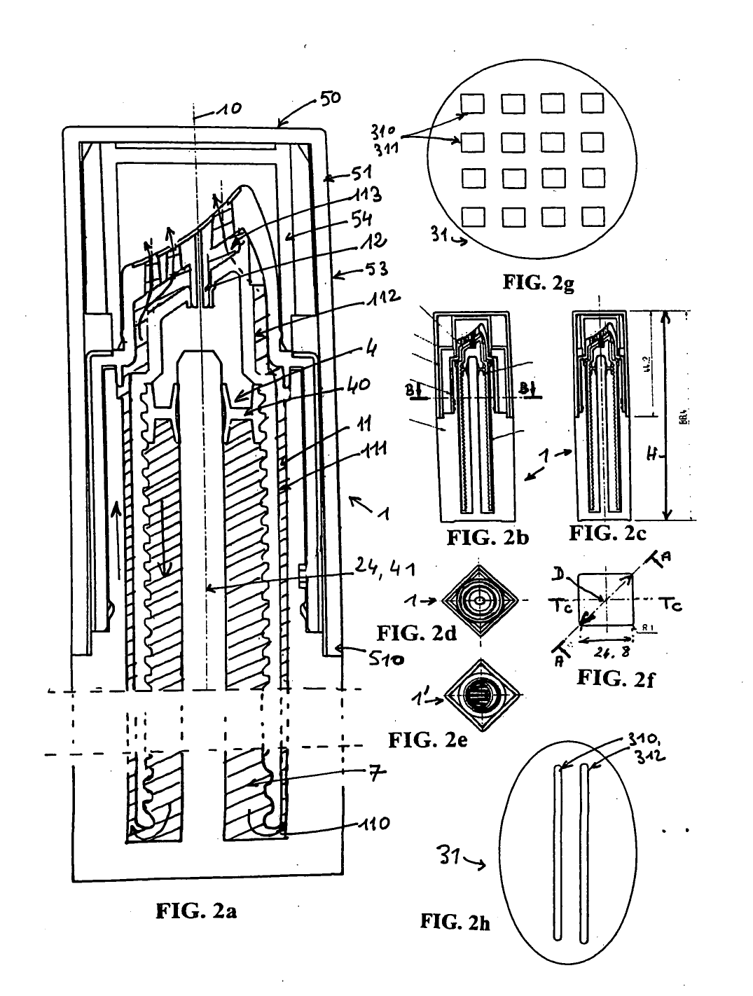

According to the invention, and as illustrated in FIGS. 2a, 2b, 2c and 2f, the said cap (5) and the said body (2) typically have the same external cross-section (52, 27) in a plane perpendicular to the said axial direction (10), so that the said dispenser (1) typically has a uniform section over its entire height H.

As illustrated particularly in FIG. 1a, the said body (2) may have an inner shoulder (25) such that a lower end (300) of the said skirt (30) of the said dispensing end piece (3) can stop in contact with the said inner shoulder (25) after assembly of the said body (2) and the said upper end piece (3).

The said body (2) and the said upper end piece (3) cooperate with an axial click-fitting means (14) typically comprising a hollow part, namely a circular groove formed on the sidewall (22) of the said body (2), cooperating with a projecting part, namely a circular rib formed on the inner surface of the side skirt (30) of the said dispensing end piece (3).

The said body (2) may have an outer shoulder (26) typically concentric with the said inner shoulder (25) such that a lower end (510) of the said skirt (51) of the said cap (5) may stop in contact with the said outer shoulder (26) when the said cap (5) closes the said dispenser (1).

The said cap (5) may click-fit onto the said dispensing end piece (3) by a click-fitting means (15) as illustrated in FIG. 1a.

According to another variant of the invention, the said side skirt (30) of the said dispensing end piece (3) may be provided with a shoulder (33) such that all or part of the said cap, and particularly a lower end (510) of the said skirt (51) of the said cap (5), can stop in contact with the said shoulder (33) when the said cap (5) closes the said dispenser (1).

As illustrated in FIGS. 1c, 1d, 1e, 2h and 2g, the said orifice (310) of the said dispensing head (31) of the said dispensing end piece (3) may form or comprise a plurality of orifices (311) typically forming a mesh, typically arranged along an inclined plane (313) forming an angle a with the said axial direction (10) varying from 30° to 90°.

The said orifice (310) of the said dispensing head (31) of the said dispensing end piece (3) may form or comprise a transverse slot (312) or a plurality of parallel slots (312′), typically arranged along an inclined plane (313) forming an angle a with the said axial direction (10) varying from 30° to 90°.

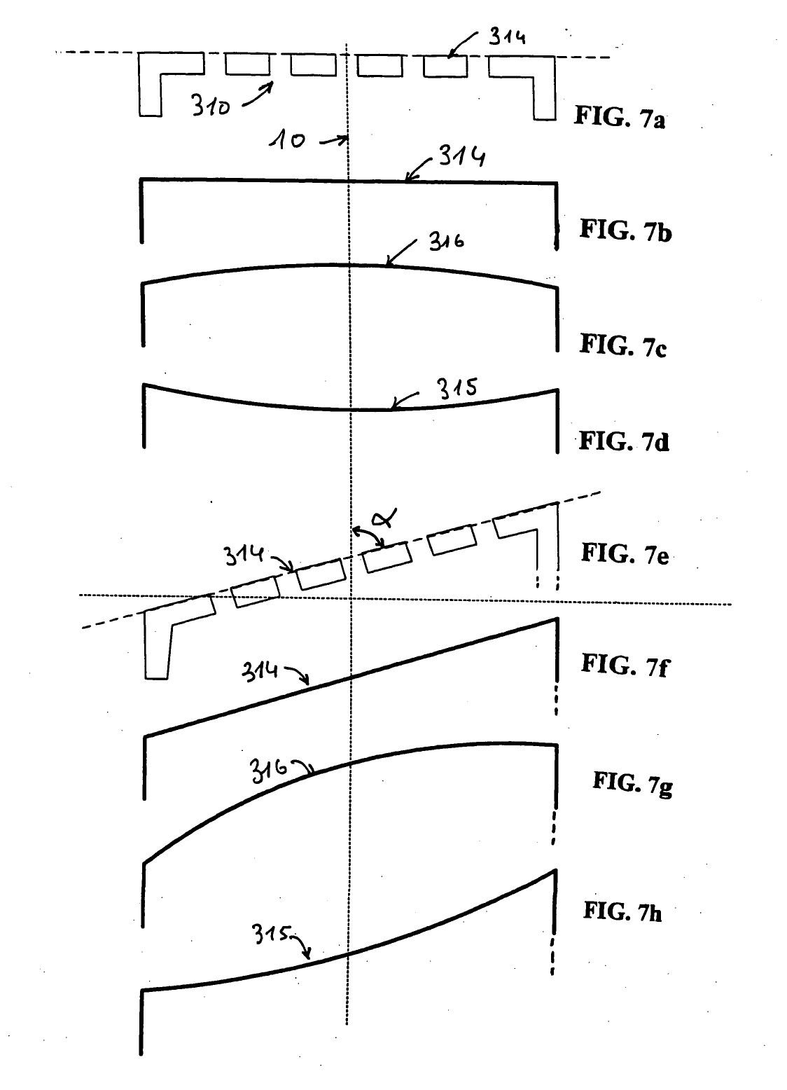

As illustrated in FIGS. 7a to 7h, the said inclined plane (313) may have either a straight profile (314) or a concave profile (315) or a convex profile (316).

Thus, there may be a concave profile with a recessed curvature similar to the curvature of lips, so that the said dispensing head (31) may be applied directly for uniform application of the said product (7).

According to the invention and as illustrated particularly in FIG. 1a, the said side skirt (30) of the said dispensing end piece (3) may include a so-called lower part (35) and the said sidewall (22) of the body (2) may include a so-called upper part (28) and a so-called lower part (29), the said lower part (35) and the said upper part (28) being concentric, the said lower part (35) being outside the said upper part (28) and cooperating in rotation along the said axial direction (10), so as to enable the said manual rotation, the said lower part (35) having a circular inner cross section (34) and the said upper part (28) having a circular outer cross section (27), so as to enable relative rotation of the said dispensing end piece (3) and the said body (3) by relative manual rotation of the said lower part (35) of the said dispensing end piece (3) and the said lower part (29) of the said body (2).

As illustrated in FIGS. 9a and 9b, the said lower part (29) of the said body (2), and typically the said cap (5), can have an outer surface with an outer cross section (27, 52) without any symmetry of revolution with respect to the said axial direction (10), and typically an oval or square section, the said outer cross section (27, 52) being taken in a plane perpendicular to the said axial direction (10).

As illustrated in FIGS. 8a and 8b, the said lower part (29) of the said body (2) and typically the said cap (5) may have an outer surface with a circular or round outer cross section (27, 52), the said outer cross section (27, 52) being taken in a plane perpendicular to the said axial direction (10).

As illustrated for example in FIGS. 3a and 3b, the said inner chamber (60) and the said piston (40) may have a circular or round cross section (600, 400).

In the case of a dispenser (1) according to FIGS. 5a to 5c, the said inner chamber (60) and the said piston (40) may have a cross section (600, 400) without any symmetry of revolution, typically an oval or square section and typically homothetic with the said outer cross section (27) of the said body (2).

As illustrated in FIGS. 1a, 2a and 3a, the said inner partition (6) and typically the said upper wall. (60) may include a means (12) of centring the said partition (6) in the said body (2).

As illustrated in FIGS. 1a and 1b, the said body (2) and the said dispensing end piece (3) may comprise a rear anti-rotation means (13) such that the said relative rotation of the said body (2) and the said dispensing end piece (3) can only take place in one direction, which allows expulsion of the said product (7) from the said inner chamber (60) towards the said dispensing head (31), so as to prevent any air return towards the said inner chamber (60).

This anti-rotation means as shown in FIG. 1b may include a ratchet system, the side skirt (30) of the dispensing end piece (3) including a toothed circular part cooperating with one or several flexible tabs fixed on the said sidewall (22) of the said body (2) facing the toothed part.

According to the invention and as illustrated in FIG. 2a, the said flow space or passage (11) creating a communication between the said inner chamber (6) and the said dispensing head (31) may include a lower space or passage (110) between the lower end (620) of the said inner skirt (62) and the said bottom (21) of the said body (2), and a peripheral flow space forming or including firstly a lower peripheral passage (111) formed between the said inner partition (6) and the said sidewall (22) of the said body (2) and secondly an upper peripheral passage (112) formed between the said inner partition (6) and the said dispensing end piece (3) such that the said product (7) can flow upwards at the output from the said inner chamber (60), in a thin typically laminar flow.

The said lower peripheral passage (111) may have a typically cylindrical cross section with a radial thickness e less than 2 mm, such that the corresponding volume is less than 1% of the volume of the said inner chamber (60) and so as to minimise the unusable quantity of product.

The said lower peripheral passage (111) may include a plurality of channels (111′), typically several grooves typically formed within the thickness of the said sidewall (22) of the said body, or within the thickness of the said inner skirt (62) of the said inner partition (6). This variant embodiment is not shown in a specific figure, but can be used to obtain decorative effects.

According to one preferred embodiment of the invention, the said body (2) and possibly the said dispensing end piece (3) may be made from a transparent material, so that the said product (7) contained in the said flow space (11) and typically in the said peripheral passages (111, 112) can be seen from the outside.

The said inner partition (6) may be made from a transparent material, and the said sidewall (22) of the said body (2) or the said inner skirt (62) of the said inner partition (6) may include an axial and radial projection extending between the said sidewall and the said inner skirt (220, 622) so as to make the position of the said piston (40) within the said inner chamber (60) visible, so that the proportion of the said product (7) consumed can also be seen. As illustrated in FIG. 5a, this axial projection (220, 622) forms a thickness of transparent material so that the level of the said product in the said inner chamber (60) can be seen. In this case, this axial projection forms an axial partition for the said flow space (11) and particularly for the said inner peripheral passage (111).

According to the invention, the said head space (113) may be limited at its lower part by the said head or upper wall (61) of the said inner partition (6), and at its upper part by the said dispensing head (31) with a spacing varying typically from 0.5 mm to 5 mm, which corresponds to a very low volume of the inevitably lost residual product compared with the volume of the said inner chamber.

As illustrated in FIGS. 10a to 10c, the said bottom (21) of the said body may be a bottom (21′) that can be click fitted into the said sidewall (22).

According to the invention, the said dispenser (1) may have an H/D ratio equal to at least 2, preferably more than 2.5, and typically between 2.9 and 6, where H is the axial height of the said dispenser and D is its largest dimension in a transverse plane perpendicular to the said axial direction as illustrated in FIGS. 2c and 2f.

The height H of the dispenser (1) may typically vary from 50 mm to 120 mm.

As illustrated in FIG. 1a, the said lower part (35) of the said dispensing end piece (3) and the said lower part (29) of the said body (2) may have heights H1 and H2 respectively, these heights H1 and H2 corresponding to the manual gripping height in order to produce relative manual rotation between the said body (2) and the said dispensing end piece (3), each of the heights H1 and H2 being equal to at least 5 mm, the ratio H1/H2 typically varying from 0.5 to 2.

Typically, these heights H1 and H2 are equal to at least 10 mm to facilitate manual gripping. One of these lower parts (35) and (29) may be grooved so as to improve the grip.

As illustrated in FIGS. 1a and 2a, the said cap (5) may cooperate, typically in a leak tight manner, with the said body (2) or the said dispensing end piece (3), typically by a screwing or click fit means.

Another purpose of the invention consists of using the dispenser (1) according to the invention as a lipstick dispenser.

Another purpose of the invention consists of using the dispenser (1) according to the invention as a dispenser of a cream or lotion to be applied to the skin.

Another purpose of the invention consists of using the dispenser (1) according to the invention as a deodorant product dispenser.

Another purpose of the invention consists of using the dispenser (1) according to the invention as an eyelid makeup dispenser.

Another purpose of the invention consists of using the dispenser (1) according to the invention for packaging of a product (7) with a viscosity at ambient temperature typically varying from 5 000 to 200 000 centipoises or milli-pascal-seconds (mPa·s).

### Example Embodiments

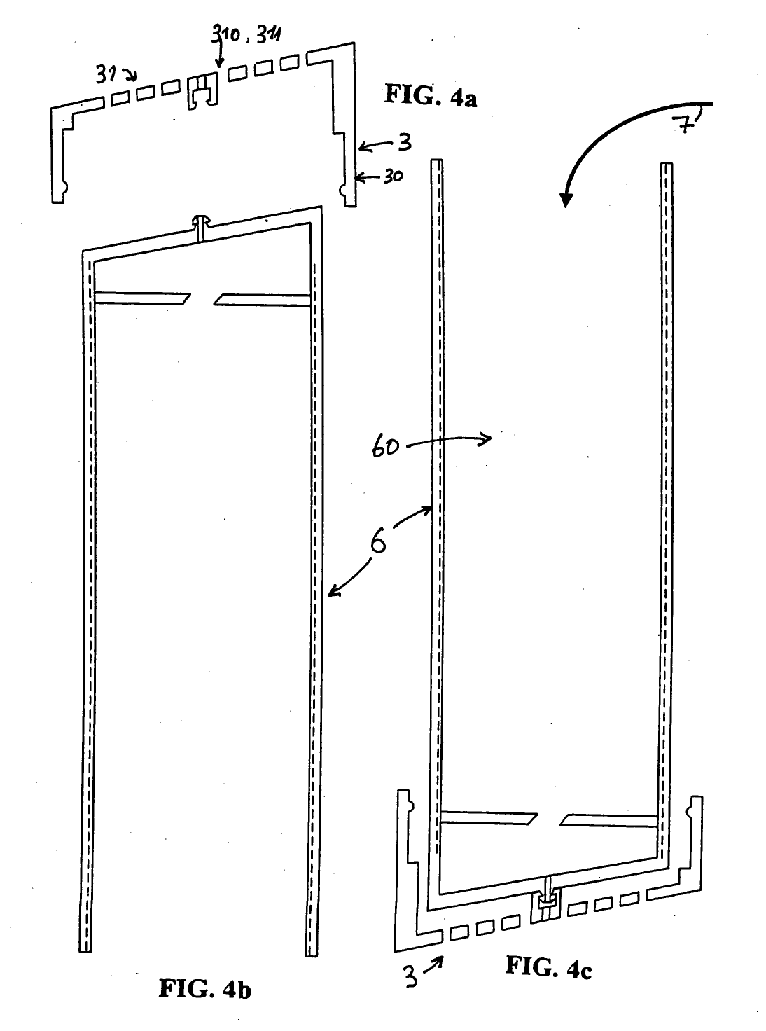

FIGS. 1a to 10 show example embodiments.

Dispensers (1) according to the invention were made by moulding component parts made of a thermoplastic material, followed by assembly typically by axial click-fitting as can be seen particularly in FIGS. 1a and 2a that are very detailed.

### ADVANTAGES OF THE INVENTION

Firstly, the dispenser (1) according to the invention is radically different from traditional dispensers (1), which is major advantage in itself for the necessary renewal of products offered to the public.

Secondly, this dispenser (1) may be adapted to a wide range of products with a wide range of viscosities.

Furthermore, this dispenser (1) comprises a dispensing head that may be adapted to the exact curvature of the part of the face to be made up.

Finally, this dispenser (1) provides a means of making the product visible in a thin layer, which is very useful in practice for choosing a precise colour, for example of a lipstick, but also aesthetically.

List of marks

| | |
|---|---|
| Dispenser | 1 |
| Dispenser without cap | 1′ |
| Axial direction | 10 |
| Flow space or passage | 11 |
| Lower passage | 110 |
| Lower peripheral passage | 111 |
| Plurality of axial channels | 111′ |
| Upper peripheral passage | 112 |
| Head space | 113 |
| Means of centring 6 in 2 & 3 | 12 |
| Anti-rotation means of 2 and 3 | 13 |
| Click-fitting means of 2 and 3 | 14 |
| Click-fitting means of 5 and 3 | 15 |
| Body | 2 |
| Axial cavity | 20 |
| Bottom | 21 |
| Bottom as moving part | 21′ |
| Click-fitting means | 210 |
| Hinge | 211 |
| Sidewall | 22 |
| Axial and radial projection | 220 |
| Lower opening | 221 |
| Upper opening | 23 |
| Central rod (=41) | 24 |
| Inner shoulder | 25 |
| Outer shoulder | 26 |
| Outer cross section | 27 |
| Upper part of 22 cooperating with 35 | 28 |
| Lower part of 22 underneath 35 | 29 |
| Dispensing end piece | 3 |
| Side skirt | 30 |
| Lower end | 300 |
| Dispensing head | 31 |
| Orifice | 310 |
| Plurality of orifices or meshes | 311 |
| Transverse slot | 312 |
| Plurality of parallel slits | 312′ |
| Inclined plane | 313 |
| Straight profile - plane surface | 314 |
| Concave profile - concave surface | 315 |
| Convex profile - convex surface | 316 |
| Central rod (=41) | 32 |
| Shoulder | 33 |
| Outer cross section | 34 |
| Lower part of 30 cooperating with 28 | 35 |
| Upper part of 30 above 28 | 36 |
| Propulsion means | 4 |
| Piston | 40 |
| Cross section | 400 |
| Centre of 40 | 401 |
| Central rod | 41 |
| Threaded central rod | 41′ |
| Outer thread (=43) | 410 |
| Threaded part of 40 | 42 |
| Peripheral threaded part | 420 |
| Central threaded part | 421 |
| Complementary threaded part of 42 | 43 |
| Cap | 5 |
| Head | 50 |
| Skirt | 51 |
| Lower end | 510 |
| Outer cross section | 510 |
| Shell | 53 |
| Sealing insert | 54 |
| Inner partition | 6 |
| Inner chamber | 60 |
| Inner cross section | 600 |
| Inner head - upper wall | 61 |
| Upper orifice | 610 |
| Inner skirt | 62 |
| Threaded inner skirt | 62′ |
| Lower end | 620 |
| Inner thread (=43) | 621 |
| Axial and radial projection | 622 |
| Anti-rotation axial groove | 623 |
| Lower opening | 63 |
| Inner shoulder | 64 |
| Product | 7 |

1. Dispenser (1) of a fluid or paste product (7) with an axial direction (10) and comprising:
a) a body (2) forming a typically cylindrical axial cavity (20), capable of containing the said product, the said body (2) comprising a bottom (21), a sidewall (22) and an upper opening (23),
b) a dispensing end piece (3) comprising a side skirt (30) capable of cooperating with the said sidewall (22) of the said body (2) so as to be axially fixed to the said sidewall through a solidarisation means while being free in rotation, and a dispensing head (31) provided with at least one orifice (310) capable of dispensing or applying the said product (7),
c) a means of propulsion (4) of the said product (7) operated by relative manual rotation of the said body (2) with respect to the said dispensing end piece (3) along the said axial direction (10), the said propulsion means (4) comprising a piston (40) and a central rod (41) cooperating with the said piston (40) at its centre (401), the said piston (40) comprising a threaded part (42) cooperating with a complementary threaded part (43) facing it, the said rotation causing relative rotation of the said threaded part (42) with respect to the said complementary threaded part (43), so as to entrain axial displacement of the said piston (40) with respect to the said central rod (41) moving the said product in the axial direction,
d) a cap (5) typically including a head (50) and a skirt (51) and capable of closing off the said dispensing head (31) of the said dispensing end piece (3),
characterised in that:
1) the said dispenser (1) includes an inner partition (6) delimiting an inner chamber (60) capable of storing the said product (7) and capable of containing the said piston (40) and the said central rod (41) of the said propulsion means, the said inner partition (6) comprising an inner head (61) forming an upper wall and a typically cylindrical inner skirt (62) forming a lower opening (63) at its lower end (620), the said inner partition (6) being in the turned over or “bell” position with respect to the said body (2),
2) the said propulsion means (4) is chosen such that the said manual rotation of the said propulsion means (4) pushes the said piston (40) and the said product (7) contained in the said inner chamber (60) downwards, i.e. towards the bottom (21) of the said body,
3) the said inner partition (6) cooperates with the said body (2) and the said dispensing end piece (3) and forms a flow space (11) forming a passage (110, 111, 111′, 112) enabling the said product to flow upwards, i.e. towards the said dispensing head (31), after passing through the said lower opening (63), to reach a head space (113) in communication with the said orifice (310), and thus dispense the said product.

2. Dispenser according to claim 1 in which the said central rod (41) is a central rod (24) fixed to the said bottom (21) of the said body (2), and typically forms a one-piece part with the said bottom (21), the said bottom (21) typically forming a one-piece part with the said sidewall (22) of the said body (2), the said inner partition (6) then being fixed in rotation to the said dispensing end piece (3).

3. Dispenser (1) according to claim 1 in which the said central rod (41) is a central rod (32) fixed to the said dispensing end piece (3) due to an upper orifice (610) formed in the said upper wall (61) of the said inner partition (62), the said inner partition (62) then being fixed in rotation to the said body (2).

4. Dispenser according to claim 1 in which the said threaded part (42) of the said piston (40) is an external peripheral threaded part (420), the said inner skirt (62) of the said inner partition (6) being provided with an inner thread (621) on its inner surface forming the said complementary threaded part (43), the said inner surface of the said inner skirt (62) being cylindrical.

5. Dispenser according to claim 1 in which the said threaded part (42) of the said piston (40) is an inner central part (421), the said central rod (41) being provided with an outer thread (410) forming the said complementary threaded part (43).

6. Dispenser according to claim 1 in which the said cap (5) and the said body (2) typically have the same external cross-section (52, 27) in a plane perpendicular to the said axial direction (10), so that the said dispenser (1) typically has a uniform section over its entire height H.

7. Dispenser according to claim 1 in which the said body (2) has an inner shoulder (25) such that a lower end (300) of the said side skirt (30) of the said dispensing end piece (3) can stop in contact with the said inner shoulder (25) after assembly of the said body (2) and the said upper end piece (3).

8. Dispenser according to claim 1 in which the said body (2) has an outer shoulder (26) typically concentric with the said inner shoulder (25) such that a lower end (510) of the said skirt (51) of the said cap (5) may stop in contact with the said outer shoulder (26) when the said cap (5) closes the said dispenser (1).

9. Dispenser according to claim 1 in which the said side skirt (30) of the said dispensing end piece (3) is provided with a shoulder (33) such that all or part of the said cap, and particularly a lower end (510) of the said skirt (51) of the said cap (5), can stop in contact with the said shoulder (33) when the said cap (5) closes the said dispenser (1).

10. Dispenser according to claim 1 in which the said orifice (310) of the said dispensing head (31) of the said dispensing end piece (3) forms or comprises a plurality of orifices (311) typically forming a mesh, typically arranged along an inclined plane (313) forming an angle α with the said axial direction (10) varying from 30° to 9°.

11. Dispenser (1) according to claim 1 in which the said orifice (310) of the said dispensing head (31) of the said dispensing end piece (3) forms or comprises a transverse slot (312) or a plurality of parallel slots (312′), typically arranged along an inclined plane (313) forming an angle α with the said axial direction (10) varying from 30° to 90°.

12. Dispenser according to claim 10 in which the said inclined plane (313) has either a straight profile (314) or a concave profile (315) or a convex profile (316).

13. Dispenser according to claim 1 in which the said side skirt (30) of the said dispensing end piece (3) includes a so-called lower part (35) and the said sidewall (22) of the body (2) includes a so-called upper part (28) and a so-called lower part (29), the said lower part (35) and the said upper part (28) being concentric, the said lower part (35) being outside the said upper part (28) and cooperating in rotation along the said axial direction (10), so as to enable the said manual rotation, the said lower part (35) having a circular inner cross section (34) and the said upper part (28) having a circular outer cross section (27), so as to enable relative rotation of the said dispensing end piece (3) and the said body (3) by relative manual rotation of the said lower part (35) of the said dispensing end piece (3) and the said lower part (29) of the said body (2).

14. Dispenser according to claim 13 in which the said lower part (29) of the said body (2), and typically the said cap (5), have an outer surface with an outer cross section (27, 52) without any symmetry of revolution with respect to the said axial direction (10), and typically an oval or square section, the said outer cross section (27, 52) being taken in a plane perpendicular to the said axial direction (10).

15. Dispenser according to claim 13 in which the said lower part (29) of the said body (2) and typically the said cap (5) have an outer surface with a circular or round outer cross section (27, 52), the said outer cross section (27, 52) being taken in a plane perpendicular to the said axial direction (10).

16. Dispenser according to claim 1 in which the said inner chamber (60) and the said piston (40) have a circular or round cross section (600, 400).

17. Dispenser according to claim 1 in which the said inner chamber (60) and the said piston (40) have a cross section (600, 400) without any symmetry of revolution, typically an oval or square section and typically homothetic with the said outer cross section (27) of the said body (2).

18. Dispenser according to claim 1 in which the said inner partition (6) and typically the said upper wall (60) includes a means (12) of centring the said partition (6) in the said body (2).

19. Dispenser according to claim 1 in which the said body (2) and the said dispensing end piece (3) comprise a rear anti-rotation means (13) such that the said relative rotation of the said body (2) and the said dispensing end piece (3) can only take place in one direction, which allows expulsion of the said product (7) from the said inner chamber (60) towards the said dispensing head (31), so as to prevent any air return towards the said inner chamber (60).

20. Dispenser according to claim 1 in which the said flow space or passage (11) creating a communication between the said inner chamber (6) and the said dispensing head (31) includes a lower space or passage (110) between the lower end (620) of the said inner skirt (62) and the said bottom (21) of the said body (2), and a peripheral flow space forming or including firstly a lower peripheral passage (111) formed between the said inner partition (6) and the said sidewall (22) of the said body (2) and secondly an upper peripheral passage (112) formed between the said inner partition (6) and the said dispensing end piece (3) such that the said product (7) can flow upwards at the output from the said inner chamber (60), in a thin typically laminar flow.

21. Dispenser according to claim 20 in which the said lower peripheral passage (111) has a typically cylindrical cross section with a radial thickness e less than 2 mm, such that the corresponding volume is less than 1% of the volume of the said inner chamber (60) and so as to minimise the unusable quantity of product.

22. Dispenser according to claim 20 in which the said lower peripheral passage (111) includes a plurality of channels (111′), typically a plurality of grooves typically formed within the thickness of the said sidewall (22) of the said body, or within the thickness of the said inner skirt (62) of the said inner partition (6).

23. Dispenser according to claim 1 in which the said body (2) and possibly the said dispensing end piece (3) are made from a transparent material, so that the said product (7) contained in the said flow space (11) and typically in the said peripheral passages (111, 112) can be seen from the outside.

24. Dispenser according to claim 23 in which the said inner partition (6) is made from a transparent material, and in which the said sidewall (22) of the said body (2) or the said inner skirt (62) of the said inner partition (6) includes an axial and radial projection extending between the said sidewall and the said inner skirt (220, 622) so as to make the position of the said piston (40) within the said inner chamber (60) visible, so that the proportion of the said product (7) consumed can also be seen.

25. Dispenser according to claim 1 in which the said head space (113) is limited at its lower part by the said head or upper wall (61) of the said inner partition (6), and at its upper part by the said dispensing head (31) with a spacing varying typically from 0.5 mm to 5 mm.

26. Dispenser according to claim 1 in which the said bottom (21) of the said body is a bottom (21′) that can be click fitted into the said sidewall (22).

27. Dispenser according to claim 1, with an H/D ratio equal to at least 2, preferably more than 2.5, and typically between 2.9 and 6, where H is the axial height of the said dispenser and D is its largest dimension in a transverse plane perpendicular to the said axial direction.

28. Dispenser according to claim 1 in which the height H of the dispenser (1) typically varies from 50 mm to 120 mm.

29. Dispenser according to claim 1 in which the said lower part (35) of the said dispensing end piece (3) and the said lower part (29) of the said body (2) may have heights H1 and H2 respectively, these heights H1 and H2 corresponding to the manual gripping heights in order to produce the said relative manual rotation between the said body (2) and the said dispensing end piece (3), each of the heights H1 and H2 being equal to at least 5 mm, the ratio H1/H2 typically varying from 0.5 to 2.

30. Dispenser according to claim 1 in which the said cap (5) cooperates, typically in a leak tight manner, with the said body (2) or the said dispensing end piece (3), typically by a screwing or click fit means.

31. Use of the dispenser (1) according to claim 1 as a lipstick dispenser.

32. Use of the dispenser (1) according to claim 1 as a dispenser of a cream or lotion to be applied to the skin.

33. Use of the dispenser (1) according to claim 1 as a deodorant product dispenser.

34. Use of the dispenser (1) according to claim 1 as an eyelid makeup dispenser.

35. Use of the dispenser (1) according to claim 1 for packaging of a product (7) with a viscosity at ambient temperature typically varying from 5 000 to 200 000 centipoises or milli-pascal-seconds (mPa·s).
